(19) United States
(12) Patent Application Publication
(10) Pub. No.: US 2018/0225020 A1
(43) Pub. Date: Aug. 9, 2018

(54) TOUCH DEVICE

(71) Applicant: Hewlett-Packard Development Company, L.P., Houston, TX (US)

(72) Inventors: Lee Lim See, Taipei (TW); Rae Chai, Taipei (TW)

(21) Appl. No.: 15/748,826

(22) PCT Filed: Oct. 30, 2015
(86) PCT No.: PCT/CN2015/093346

§ 371 Date: Jan. 30, 2018

(51) Int. Cl. G06F 3/0488; G06F 3/041; G06F 3/044

(52) U.S. Cl. CPC G06F 3/0488; G06F 3/0416; G06F 2203/04806; G06F 3/0412; G06F 3/044

(57) ABSTRACT

A touch device is disclosed. The touch device includes a touch screen to receive an input; a switching unit to receive a capacitive touch and provide a trigger signal in response to the capacitive touch; a memory to store a first set of input instructions and a second set of input instructions that are different from the first set of input instructions, wherein each input instruction of the first set of input instructions corresponds to respective inputs detected on a touch screen of the touch device, and each input instruction of the second set of input instructions corresponds to the respective inputs detected on the touch screen of the touch device; a processor, coupled to the touch screen, the switching unit and the memory, to: determine whether the trigger signal is obtained; if no trigger signal is obtained, determine the first set of input instructions as a present set of input instructions; if the trigger signal is obtained, determine the second set of input instructions as the present set of input instructions; and execute an input instruction corresponding to the received input according to the present set of input instructions.

### BACKGROUND

A touch device, for example a handset, a laptop, or a computer, generally includes a touch screen which is an input/output device that allows the user to interact with the touch device by touching the touch screen. The touch screen receives touch input and displays information of the touch input on the same screen.

In use of a touch device, users may give touch inputs with various gestures by using multiple finger motions. There are many kinds of gestures, such as “Tap”, “Drap”, “Swipe”, “Pinch”, etc., and one kind of gesture or a combination of several kinds of gestures corresponds to one input function, for example, users can slide their fingers on the touch screen and the touch screen accordingly performs respective function which has been fixed by touch screen makers.

### BRIEF DESCRIPTION OF THE DRAWINGS

FIG. 1 is an isometric view of an example of a touch device.

FIG. 2 is a schematic diagram illustrating an example of a touch device.

FIG. 3 is a block diagram of an example of a switching unit according to an example.

FIG. 4 is an illustration of input instructions of an input detected on touch screen according to one example.

FIG. 5 is a flow chart of a method for executing a certain input function of an input detected on the touch screen according to an example.

FIG. 6 is a flow chart of a method for executing a certain input function of an input detected on the touch screen according to another example.

### DETAILED DESCRIPTION

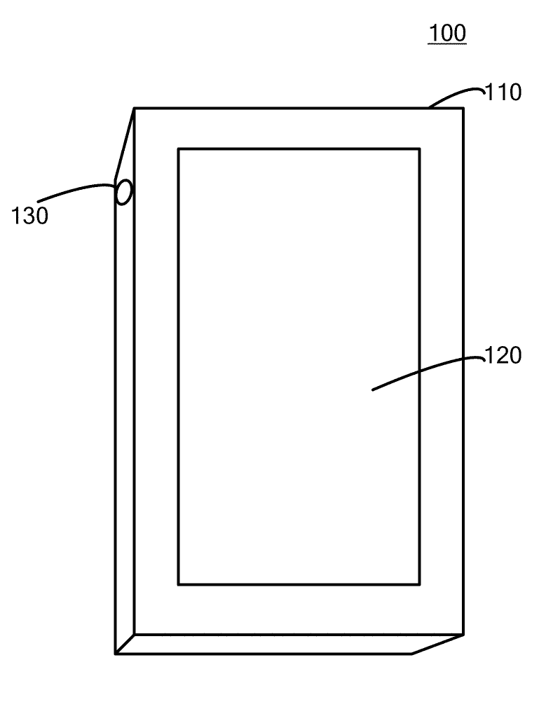

FIG. 1 is an isometric view of an illustration of a touch device 100. The touch device 100 can be a hand held electronic device, such as a mobile phone, a Personal Digital Assistant (PDA), a smart phone, a multimedia player, a digital broadcast receiver, or any other devices that include a touch screen. The touch device 100 includes, without limitation, a housing 110, a touch screen 120 and a touch switch 130. The housing 110 holds the touch screen 120, the touch switch 130 and a controller (not shown). The touch screen 120 receives user's input detected on it and displays the instruction of user's input. For example, the instruction indicates the function corresponding to the user's input. The touch switch 130 is to receive user's touch and provide a trigger signal for switching a present set of input instructions which is stored in the controller. The controller executes the input instruction corresponding to the user's input according to the present set of input instructions. In an example, the touch switch 130 includes a sensory area. The area is arranged convenient for a user's thumb to lay on. In an example, the touch switch 130 is actuated by the user′ capacitive touch on the sensory area. In an example, the sensory area may be outside the touch screen 120 and around the top left side of the touch device 100 where for a right hander, he/she may lay the left thumb on the sensory area, and for a left hander, his/her right hand index finger may assess the sensory area. In an example, the touch switch 130 may include two sensory areas (not shown) to trigger two trigger signals. For example, one sensory area is outside the touch screen 120 and on the top left of the surface of the touch device 100, and another sensory area is outside the touch screen 120 and on the top right of the surface of the touch device 100.

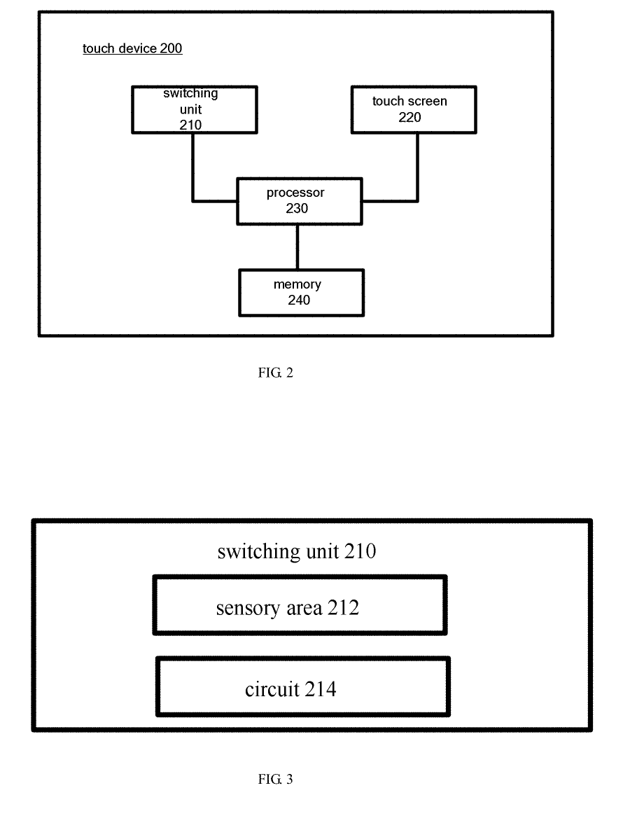

FIG. 2 is a schematic diagram illustrating an example of a touch device. The touch device 200 includes a switching unit 210, a touch screen 220, a memory 240 and a processor 230 coupled to the touch screen 220, the switching unit 210 and the memory 240.

In one example, the touch screen 220 receives an input DX conduced by a user. The input DX can be one kind of the user's gesture, such as move, rotate, zoom, or a combination of two or more kinds of the user's gestures. The switching unit 210 receives a capacitive touch by the user and provides a trigger signal in response to the user's capacitive touch. The memory 240 stores a first set of input instructions F1 and a second set of input instructions F2 that are different from the first set of input instructions F1, wherein each input instruction of the first set of input instructions F1 corresponds to respective inputs detected on the touch screen 220 of the touch device 200, and each input instruction of the second set of input instructions F2 corresponds to the respective inputs detected on the touch screen 220 of the touch device 200. The processor 230 determines whether the trigger signal is obtained. In one case, the trigger signal is not obtained, and then the processor 230 determines the first set of input instructions F1 as a present set of input instructions and executes an input instruction corresponding to the received input DX according to the present set of input instructions, i.e. the first set of input instructions F1. In another case, the trigger signal is obtained, and then the processor 230 determines the second set of input instructions F2 as the present set of input instructions and executes an input instruction corresponding to the received input DX according to the present set of input instructions, i.e. the second set of input instructions F2. Herein executing an input instruction means achieving the function corresponding to the input, and the input instruction may be one instruction or may include a set of instructions.

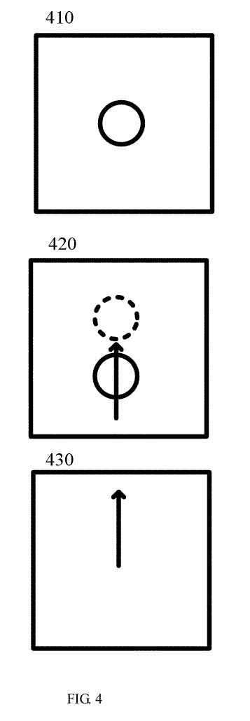

FIG. 3 is a block diagram of an example of a switching unit according to an example. Referring to FIG. 3, the switching unit 210 comprises a sensory area 212 for receiving the capacitive touch and a circuit 214 for providing the trigger signal in response to the capacitive touch. The sensory area 212 arranged outside the touch screen 220, for example, the sensory area is beyond the touch screen 220 and on the surface of the touch device 200. When the sensory area receives a capacitive touch detected on it by the user, the circuit 214 detects a capacitance resistance change and generates the trigger signal.

In an example, the user's capacitive touch may be performed in the way that the user lays his/her thumb on the sensory area, and the trigger signal is activated. In other words, the trigger signal is activated as long as user's thumb laying on the sensory area. In an example, the trigger signal may be embodied in the way of high level effective or low level effective. When the trigger signal is activated, the second set of input instructions F2 is the present set of input instructions. On the contrary, the trigger signal is not activated if no capacitive touch on the sensory area 212. When the trigger signal is not activated, the first set of input instructions F1 is the present set of input instructions.

In memory 240, in an example, each input instruction of the first set of input instructions F1 may map to one of user's inputs according to one kind of one-to-one mapping relationship, and each input instruction of the second set of input instructions F2 may map to one of user's inputs according to another kind of one-to-one mapping relationship. In other words, the same input DX detected on the touch screen 220 is associated with two input instructions, i.e. one is defined in the first set of input instructions F1 and another is defined in the second set of input instructions F2. When the touch screen 220 receives the input DX, the processor 230 executes one input instruction of the two, depending on whether the trigger signal is activated. According to such an example, different input instructions can be achieved by just touching a sensory area with the same input DX.

In such an example, the touch screen 220 may be implemented as the touch screen 120 shown in FIG. 1. The switching unit 210 may be implemented as the touch switch 130 shown in FIG. 1. The memory 240 and the processor 230 may be implemented as the controller in FIG. 1.

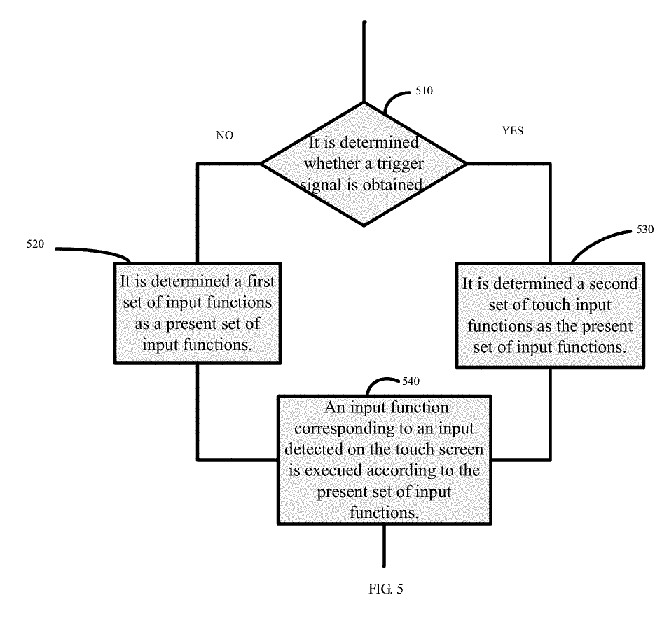

FIG. 4 is an illustration of input instructions of an input detected on touch screen. The touch screen is configured to display an original image 410 and receive an input DX on it. The input DX is for example a gesture of moving up. When the trigger signal is not activated, the input instruction corresponding to the input DX in present set of input instructions, i.e. the first set of input instructions F1 can manipulate the original image 410 to go to an upper position of the touch screen (see 420). When the trigger signal is activated by for example user's capacitive touch on the sensory area, the input instruction corresponding to the input DX in present set of input instructions, i.e. the second set of input instructions F2 can manipulate the original image 410 to be deleted (see 430).

In another example, the touch screen 220 receives an input DX, the input DX is conducted by a user and can be one kind of user's gesture, such as move, rotate, zoom, or a combination of two or more kinds of the user's gestures. The switching unit 210 receives a capacitive touch by the user and provides a first trigger signal in response to the user's capacitive touch. The memory 240 stores a first set of input instructions F1 and a second set of input instructions F2 that are different from the first set of input instructions F1. Each input instruction of the first set of input instructions F1 corresponds to respective inputs detected on the touch screen 220 of the touch device 200. Each input instruction of the second set of input instructions F2 corresponds to the respective inputs detected on the touch screen 220 of the touch device 200. The processor 230 determines a present set of input instructions in response to the first trigger signal, and the present set of input instructions is switched from the first set of input instructions F1 to the second set of touch input instructions F2. The processor 230 executes an input instruction corresponding to the received input DX according to the present set of input instructions, i.e. the second set of input instructions F2.

In an example, the memory 240 stores a third set of input instructions F3 that are different form the first set of input instructions F1 and the second set of input instructions F2. Each input instruction of the third set of input instructions F3 corresponds to the respective inputs detected on the touch screen 220 of the touch device 200. The switching unit 210 receives a second capacitive touch and provides a second trigger signal in response to the second capacitive touch. The processor 230 determines the present set of input instructions in response to the second trigger signal, the present set of input instructions being switched from the second set of input instructions F2 to the third set of touch input instructions F3. The processor 230 executes an input instruction corresponding to the received input DX according to the present set of input instructions, i.e. the third set of input instructions F3.

In an example, the switching unit 210 comprises a sensory area 212 arranged outside the touch screen 220, for example, the sensory area 212 is beyond the touch screen 220 and on the surface of the touch device 200. The processor 230 senses the input DX detected on the touch screen 220, and based on the sensed input DX according to the present set of input instructions, performs the input instruction corresponding to the sensed touch input.

In an example, user may click the sensory area 212 to activate the first trigger signal or the second trigger signal. For example, a user click the sensory area 212 one time, the present set of input instructions is switched from the first set of input instructions F1 to the second set of input instructions F2, then the user click the sensory area 212 another time, the present set of input instructions is switched from the second set of input instructions F2 to the third set of input instructions F3, then the user click the sensory area 212 one more time, the present set of input instructions is switched from the third set of input instructions F3 to the first set of input instructions F1. When it is desired to switch the present set of input instructions from the second set of input instructions F2 to the first set of input instructions F1, user may click the sensory area 212 two times, one time for switching the present set of input instructions from the second set of input instructions F2 to the third set of input instructions F3, and another time for switching the present set of input instructions from the third set of input instructions F3 to the first set of input instructions F1. In such an example, the first and the second trigger signal may be embodied in the way of edge trigging.

In such an example, the touch screen 220 may be implemented as the touch screen 120 shown in FIG. 1. The switching unit 210 may be implemented as the touch switch 130 shown in FIG. 1. The memory 240 and the processor 230 may be implemented as the controller in FIG. 1.

In another example, the switching unit 210 may be embodied as the touch switch 130 as described above. For example, the switch 130 includes a first sensory area on the top left of the surface of the touch device 200, and a second sensory area on the top right of the surface of the touch device 200. In an example, when a capacitive touch is sensed from the first sensory area, one trigger signal is generated to determine the second set of input instructions F2 as the present set of input instructions; when a capacitive touch is sensed from the second sensory area, another trigger signal is generated to determine the third set of input instructions F3 as the present set of input instructions; when no capacitive touch is sensed, no trigger signal is generated, and it is determined the original set of input instructions (i.e. the first set of input instructions F1) as the present set of input instructions.

In an example, there are more than three sets of input instructions and more than two trigger signals. Similarly, switching one set of input instructions to the next set of input instructions is achieved by actuated one trigger signal. There is a mechanical button (not shown) on a side of the touch device 200. When the mechanical button is pressed, the present set of input instructions goes back to the original set of input instructions, i.e. the first set of input instructions F1.

In such an example, the touch screen 220 may be implemented as the touch screen 120 shown in FIG. 1. The switching unit 210 may be implemented as the touch switch 130 shown in FIG. 1 and a mechanical button as described above. The memory 240 and the processor 230 may be implemented as the controller in FIG. 1.

Alternatively, the touch switches and the mechanical button may be used with any other combinations in order to achieve other switching schemas and go back the original set of input instruction.

FIG. 5 is a flow chart of a method for executing a certain input function of an input detected on the touch screen according to an example. Such a method can be implemented in a hand held electronic device, such as a mobile phone, a Personal Digital Assistant (PDA), a smart phone, a multimedia player, a digital broadcast receiver, or any other device that include a touch screen display and can be held in a hand of a user.

Referring to FIG. 5, at block 510, it is determined whether a trigger signal is obtained. The trigger signal is generated from a capacitive touch on an area of a touch device.

In an example, it is detected whether there is a capacitance resistance change resulting from the capacitive touch on the area. If the capacitance resistance change is detected, determining that the trigger signal is obtained.

If no trigger signal is obtained, the method goes to block 520. At block 520, it is determined a first set of input functions as a present set of input functions. Each input function of the first set of input functions corresponds to respective inputs detected on a touch screen of the touch device.

If the trigger signal is obtained, the method goes to block 530. At block 530, it is determined a second set of touch input functions as the present set of input functions, the second set of input functions different from the first set of input functions. Each input function of the second set of input functions corresponds to the respective inputs detected on the touch screen of the touch device.

At block 540, an input function is executed corresponding to an input detected on the touch screen according to the present set of input functions.

In an example, the input detected on the touch screen is sensed, and based on the sensed input according to the present set of input functions, performing the input function corresponding to the sensed touch input.

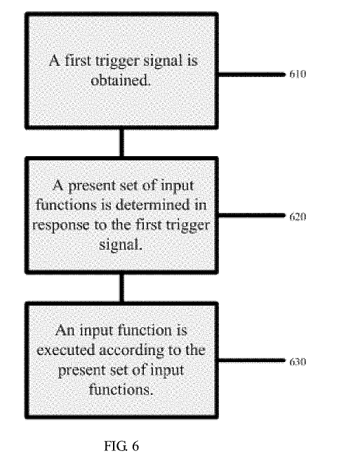

FIG. 6 is a flow chart of a method for executing a certain input function of an input detected on the touch screen according to another example. Such a method can be implemented in a hand held electronic device, such as a mobile phone, a Personal Digital Assistant (PDA), a smart phone, a multimedia player, a digital broadcast receiver, or any other device that include a touch screen display and can be held in a hand of a user.

Referring to FIG. 6, at block 610, a trigger signal is obtained. The trigger signal is generated from a capacitive touch on an area of a touch device. In an example, a capacitive resistance change can be felt due to the capacitive touch, and the trigger signal is generated in response to the capacitive resistance change.

At block 620, it is determined a present set of input functions in response to the trigger signal, the present set of input functions being switched from a first set of input functions to a second set of touch input functions that are different from the first set of input functions. Each input function of the first set of input functions corresponds to respective inputs detected on a touch screen of the touch device, and each input function of the second set of input functions corresponds to the respective inputs detected on the touch screen of the touch device.

At block 630, an input function corresponding to an input detected on the touch screen is executed according to the present set of input functions.

The foregoing disclosure describes a number of examples for notifying an operator of an object left behind. It should be appreciated the described examples intend to illustrate rather than limit the subject matter defined by the following claims. Thus the claims are not intended to be limited to the illustrated details of the examples, but are to be accorded the full scope consistent with the language of the claims.

1. A method, comprising:
determining whether a trigger signal is obtained, wherein the trigger signal is generated from a capacitive touch on an area of a touch device;
if no trigger signal is obtained, determining a first set of input functions as a present set of input functions, wherein each input function of the first set of input functions corresponds to respective inputs detected on a touch screen of the touch device;
if the trigger signal is obtained, determining a second set of touch input functions as the present set of input functions, the second set of input functions different from the first set of input functions, wherein each input function of the second set of input functions corresponds to the respective inputs detected on the touch screen of the touch device; and
executing an input function corresponding to an input detected on the touch screen according to the present set of input functions.

2. The method of claim 1, wherein the executing comprises:
sensing the input detected on the touch screen; and
based on the sensed input according to the present set of input functions, performing the input function corresponding to the sensed touch input.

3. The method of claim 1, wherein determining whether the trigger signal is obtained comprises:
detecting whether there is a capacitance resistance change resulting from the capacitive touch on the area; and
if the capacitance resistance change is detected, determining that the trigger signal is obtained.

4. A method, comprising:
obtaining a first trigger signal, wherein the first trigger signal is generated from a first capacitive touch on an area of a touch device;
determining a present set of input functions in response to the first trigger signal, the present set of input functions being switched from a first set of input functions to a second set of touch input functions that are different from the first set of input functions, wherein each input function of the first set of input functions corresponds to respective inputs detected on a touch screen of the touch device, and each input function of the second set of input functions corresponds to the respective inputs detected on the touch screen of the touch device; and
executing an input function corresponding to an input detected on the touch screen according to the present set of input functions.

5. The method of claim 4, comprising:
obtaining a second trigger signal, wherein the second trigger signal is generated from a second capacitive touch on the area of the touch device; and
determining the present set of input functions in response to the second trigger signal, the present set of input functions being switched from the second set of input functions to a third set of touch input functions that are different from the first set of input functions and the second set of input functions, wherein each input function of the third set of input functions corresponds to the respective inputs detected on the touch screen of the touch device.

6. The method of claim 4, wherein the executing comprises:
sensing the input detected on the touch screen; and
based on the sensed input according to the present set of input functions, performing the input function corresponding to the sensed touch input.

7. The method of claim 5, wherein the executing comprises:
sensing the input detected on the touch screen; and
based on the sensed input according to the present set of input functions, performing the input function corresponding to the sensed touch input.

8. A touch device, comprising:
a touch screen to receive an input;
a switching unit to receive a capacitive touch and provide a trigger signal in response to the capacitive touch;
a memory to store a first set of input instructions and a second set of input instructions that are different from the first set of input instructions, wherein each input instruction of the first set of input instructions corresponds to respective inputs detected on a touch screen of the touch device, and each input instruction of the second set of input instructions corresponds to the respective inputs detected on the touch screen of the touch device; and
a processor, coupled to the touch screen, the switching unit and the memory, to:
determine whether the trigger signal is obtained;
if no trigger signal is obtained, determine the first set of input instructions as a present set of input instructions;
if the trigger signal is obtained, determine the second set of input instructions as the present set of input instructions; and
execute an input instruction corresponding to the received input according to the present set of input instructions.

9. The touch device of claim 8, wherein the switching unit comprises a sensory area arranged outside the touch screen, and the switching unit is to:
receive the capacitive touch detected on the sensory area;
detect whether there is a capacitance resistance change resulting from the capacitive touch; and
generate the trigger signal if the capacitance resistance change is detected.

10. A touch device, comprising:
a touch screen to receive an input;
a switching unit to receive a first capacitive touch and provide a first trigger signal in response to the first capacitive touch;
a memory to store a first set of input instructions and a second set of input instructions that are different from the first set of input instructions, wherein each input instruction of the first set of input instructions corresponds to respective inputs detected on a touch screen of the touch device, and each input instruction of the second set of input instructions corresponds to the respective inputs detected on the touch screen of the touch device; and
a processor, coupled to the touch screen, the switching unit and the memory, to:
determine a present set of input instructions in response to the first trigger signal, the present set of input instructions being switched from the first set of input instructions to the second set of touch input instructions; and
execute an input instruction corresponding to the received input according to the present set of input instructions.

11. The touch device of claim 10, wherein the switching unit is to receive a second capacitive touch and provide a second trigger signal in response to the second capacitive touch, and wherein the memory is to store a third set of input instructions that are different from the first set of input instructions and the second set of input instructions, and each input instruction of the third set of input instructions corresponds to the respective inputs detected on the touch screen of the touch device; and wherein the processor is to determine the present set of input instructions in response to the second trigger signal, the present set of input instructions being switched from the second set of input instructions to the third set of touch input instructions.

12. The touch device of claim 10, wherein the switching unit comprises a sensory area arranged outside the touch screen, and the processor is to:
sense the input detected on the touch screen; and
based on the sensed input according to the present set of input instructions, perform the input instruction corresponding to the sensed touch input.

13. The touch device of claim 11, wherein the switching unit comprises a sensory area arranged outside the touch screen, and the processor is to:
sense the input detected on the touch screen; and
based on the sensed input according to the present set of input instructions, perform the input instruction corresponding to the sensed touch input.
